(19) United States
(12) Patent Application Publication
(10) Pub. No.: US 2011/0149560 A1
(43) Pub. Date: Jun. 23, 2011

(54) SYSTEM AND METHOD FOR INTERFACING PORTABLE HAND-HELD DEVICES

(75) Inventors: Fred L. Jessup, Moscow, ID (US); David G. Alexander, Moscow, ID (US); Michael R. Maughan, Moscow, ID (US); Erik J. Cegnar, Moscow, ID (US)

(73) Assignee: IVUS INDUSTRIES, LLC, Moscow, ID (US)

(21) Appl. No.: 12/977,751

(22) Filed: Dec. 23, 2010

Related U.S. Application Data
(60) Provisional application No. 61/289,395, filed on Dec. 23, 2009.

(51) Int. Cl. F21L 4/08; H02J 7/00

(52) U.S. Cl. 362/183; 320/115

(57) ABSTRACT

A system and method for interfacing a charger with a portable hand-held electronic device via one or more magnetic portions.

### PRIORITY/CROSS-REFERENCE TO RELATED APPLICATIONS

This application claims the benefit of U.S. Provisional Application No. 61/289,395, filed Dec. 23, 2009, the disclosure of which is incorporated herein by reference.

### TECHNICAL FIELD

The disclosure generally relates to the field of electronics. Particular embodiments relate to systems, processes, methods and interfaces for chargers and electrical devices.

### BACKGROUND

Electronic devices with rechargeable energy storage have some means by which they are recharged. Many of these devices have been designed to function as a system with a corresponding charger. Where the charging connection is not simply a plug, the device to be charged is generally stored in the charger when not in use.

There have been many methods employed to interface electronic devices. These include spring clips, friction, mechanical coupling, and threads.

### SUMMARY OF THE DISCLOSURE

Described herein is a system and method for interfacing a charger with a portable hand-held electronic device(s) using one or more magnetic portions.

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the inventive concept(s) of the application, which is measured by the claims, nor is it intended to be limiting as to the scope of the inventive concept(s) in any way.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 is a partial, exploded side view of a first embodiment of the inventive concept showing the electrical device and the base separated.

FIG. 2 is a partial, side view of the embodiment of FIG. 1 showing the electrical device and the base mated.

FIG. 3 is a perspective view of the embodiment of FIG. 2.

FIG. 4 is a perspective view of the embodiment of FIG. 1.

FIG. 5 is a plan view of a second embodiment of the inventive concept showing the electrical device and accessory separated.

FIG. 6 is a perspective, environmental view of the embodiment of FIG. 5 showing the electrical device and accessory connected.

### DEFINITIONS

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

The use of “rechargeable battery” means a group of one or more secondary electrochemical cells, unless otherwise noted. Examples of such secondary electrochemical cells include, but are not limited to, lead-acid batteries, nickel cadmium (NiCd) batteries, nickel metal hydride (NiMH) batteries, lithium-ion (Li-ion) batteries, lithium polymer, lithium-ion polymer (Li-ion polymer) batteries, lithium iron phosphate batteries, batteries including nanophosphate, lithium-titanate batteries, and “advanced batteries” which require some form of a management system.

The use of “advanced capacitor” means any device where one or more of the electrodes utilize the double layer effect, unless otherwise noted. Examples of such devices include, but are not limited to, electric double layer capacitors (EDLC), lithium capacitors, lithium ion capacitors (LIC), and pseudocapacitors. Electric double layer capacitors are also known as ultracapacitors or supercapacitors. Pseudocapacitors are also known as hybrid capacitors. Reference herein to one particular type of advanced capacitor is intended to likewise apply to any other type of advanced capacitor, for instance, reference to an ultracapacitor is intended to likewise include reference to a pseudocapacitor.

The use of “electrical device” means a device powered by an energy storage device or energy pack, an energy storage device or energy pack itself, and/or a device powered by and including an energy storage device or energy pack, unless otherwise noted. The energy storage device or energy pack may be integral to the electrical device (where the energy storage device is charged by plugging the electrical device into a charger) or separate from the electrical device (the energy storage device or energy pack is removed from the electrical device before the energy storage device or energy pack is charged). The preferred “electrical device” is a rechargeable flashlight.

The use of “energy storage device” means a cell that stores electrical energy for powering an electrical device, unless otherwise noted. Energy storage devices include, but are not limited to, rechargeable batteries, capacitors, advanced capacitors, and combinations thereof.

The use of “energy pack” means a device consisting of one or more energy storage device cells of one or more types of cell chemistries, unless otherwise noted. An energy pack can be configured to interface with another system for functions such as charging and/or discharging, for instance being configured for connection to a charging system and/or integrated into an electrical device which is configured for connection to a charging system.

The use of “management circuit” means a process and method for optimizing a particular performance objective by: measuring various energy storage parameters, making decisions based on these parameters, and commanding or halting the transfer of electrical energy accordingly, unless otherwise noted.

The use of “charging system” means a system for the charging and/or discharging of at least one energy storage device, unless otherwise noted.

The use of “charger device” means a device connected to a power source and used for charging or recharging at least one energy storage device, unless otherwise noted.

The use of “magnetic portion” is intended to include magnets (e.g., permanent rare earth magnets, electromagnets) as well as to broadly include ferromagnetic material which itself is not “magnetic” but is instead able to be magnetically attracted to a “magnetic portion,” unless otherwise noted.

The use of “light source” is intended to include all electrically powered light sources (e.g., light emitting diodes (LEDs), incandescent bulbs), unless otherwise noted.

### DETAILED DESCRIPTION OF THE EXEMPLARY EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific forms disclosed. On the contrary, the presently disclosed and claimed inventive concept(s) is to cover all modifications, alternative constructions, and equivalents falling within the spirit and scope of the inventive concept(s) as defined in the claims.

Described herein is a system and method for interfacing one or more portable hand-held electronic devices with a charger device or charging system using one or more magnetic portions. Preferably, the connection is accomplished by at least one magnetic portion mounted in one or both the charger device and the housing of the flashlight (portable hand-held electronic device) it is intended to charge.

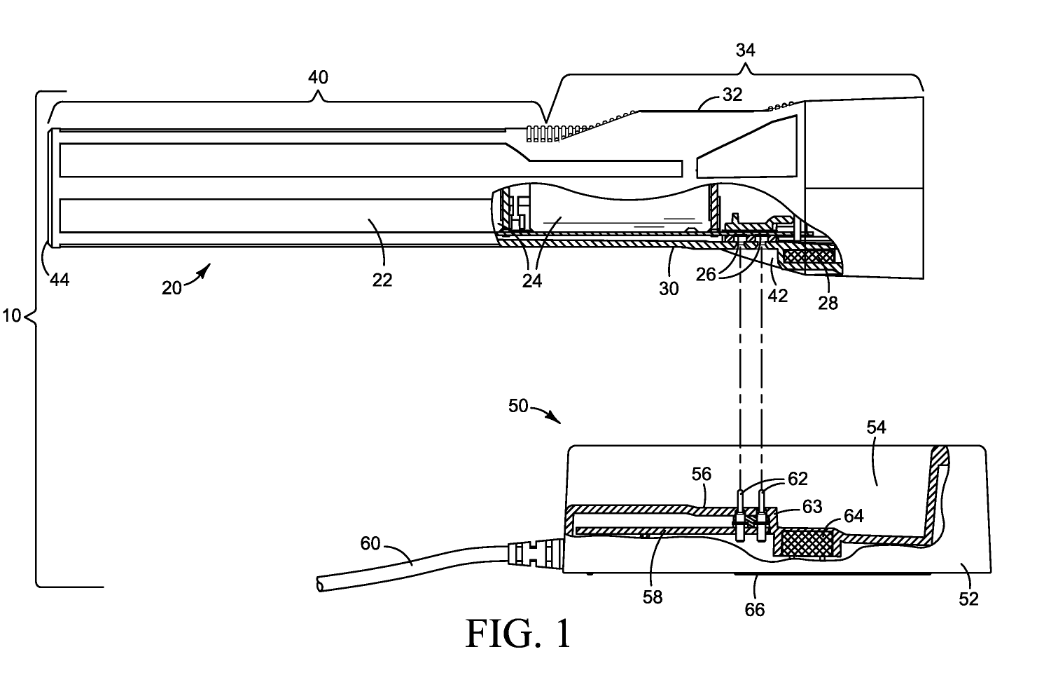

FIG. 1 illustrates a first embodiment of the system and method for interfacing portable hand-held devices. In the first illustrated embodiment, the system 10 comprises a charging base 50 and an electrical device. The electrical device in this illustrated embodiment comprising a rechargeable flashlight 20.

The base 50 having a body 52 and a charger 58. The charger 58 connected to a power source (not shown) by a connection such as an electrical cord 60 or a plug (not shown) for plugging directly into a wall outlet, cigarette lighter or other power source. The power source can be any suitable source, including but not limited to automotive 12 v power, solar panels, and household 120 v current. The charger 58 for charging the energy pack 24 of the electrical device. The charger 58 preferably including power management circuitry (management circuit) for controlling the charging of the energy pack 24 of the rechargeable flashlight 20.

In the first illustrated embodiment, the base 50 defines a receiver portion 54 in said body 52. The receiver portion 54 preferably shaped for nesting receipt therein of a portion of the electrical device, for instance the head portion 34 of the rechargeable flashlight 20.

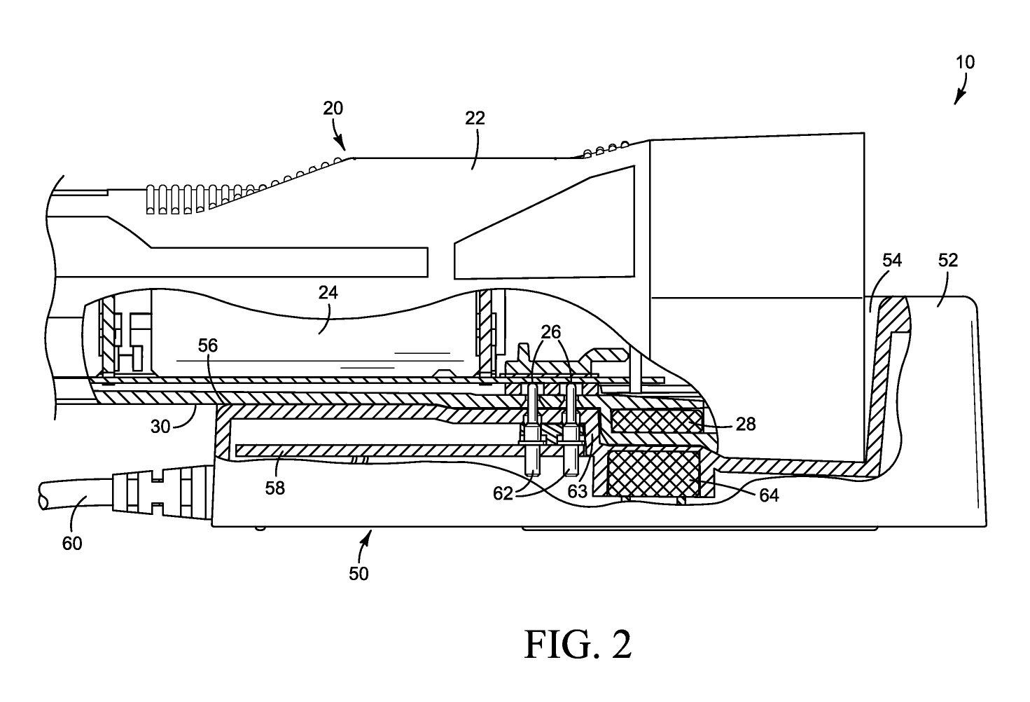

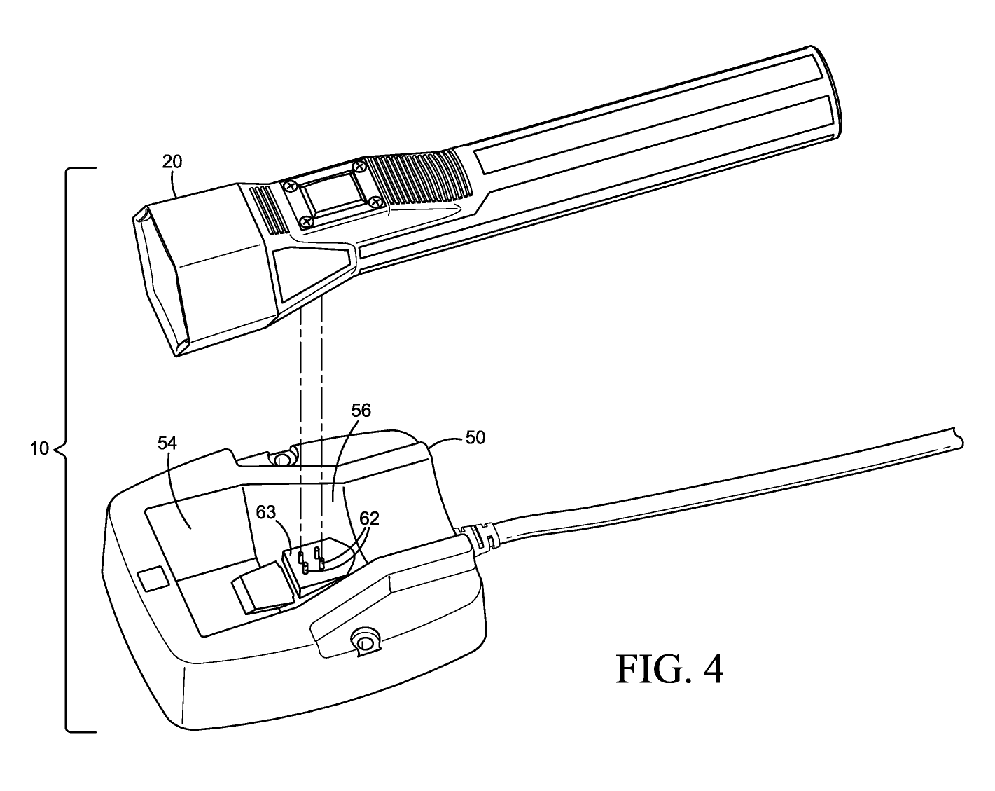

It is preferred that the charger 58 comprise at least one electrical contact 62 in said receiver portion 54. It is preferred that the electrical contact(s) 62 be part of or connected to a charger circuit board (base circuit board). In the embodiment illustrated in FIG. 1 through FIG. 4, the charger 58 comprises four contacts 62, as particularly shown in FIG. 4. The preferred embodiment utilizes an energy pack comprising a number of advanced capacitors in series, preferably ultracapacitors or pseudocapacitors. Such advanced capacitors have the advantage of being charged and/or discharged quickly, but require more current to do so. Thus, the connections need to be more robust than when using a slow charge battery. Additionally, it is wise to provide balancing when charging more than one advanced capacitor in series, thereby requiring more connections (contacts) than the simple “positive” and “negative” required for recharging a battery.

In this illustrated embodiment, these four electrical contacts 62 comprise spring probes, aka “pogo” pins. While spring probes are preferred, the electrical connection could also be accomplished via exposed metal contacts, or by other means such as inductive coupling.

The electrical contacts 62 are preferably located within the receiver portion 54 and are thereby protected from accidental contact with foreign objects. The electrical contacts 62 are preferably located on a projection 63 extending from the body first side 56. The projection 63 located within the receiver portion 54. In the embodiment illustrated in FIG. 1 through FIG. 4 and as discussed below, the housing 22 of the flashlight 20 defines recess 42 therein for receiving or mating with the projection 63. It is preferred that the electrical contact(s) 62 extend from the receiver portion 54 in position to connect with one or more electrical contacts 26 on said rechargeable flashlight 20, as discussed below.

Preferably, the charger 58 is a four-wire universal bus that allows the electrical contacts 62 to have virtually no electrical potential in relation to one another while the energy pack (or electrical device including an energy pack) is disconnected from the charging system.

The body 52 having a second side 66 that is preferably configured for attaching to (e.g., bolting to the floor or other surface of a vehicle) or resting upon a surface. This allows the flashlight to more easily be removed from the base 50 by a user.

The base 50, preferably at said receiver portion 54, further comprising at least one first magnetic portion 64. It is preferred that the first magnetic portion 64 comprise one or more magnets located in said base 50 within said receiver portion 54. While the illustrated embodiment includes a first magnetic portion 64, other embodiments may instead include a ferromagnetic portion able to be attracted to a magnetic portion located in the electrical device. It is preferred that the first magnetic portion 64 be located in said receiver portion 54 adjacent said at least one electrical contact 62.

The electrical device, e.g., rechargeable flashlight 20, comprising a housing 22. The rechargeable flashlight 20 further comprising, within said housing 22, at least one energy pack. Preferably, the energy pack 24 comprises a least one advanced capacitor for storing energy. While the illustrated embodiment of FIG. 1 through FIG. 4 utilizes one or more advanced capacitors, in other embodiments rechargeable batteries could be utilized instead.

It is preferred that the electrical device comprise at least one electrical contact. It is preferred that the electrical contact(s) exist on or connect to an electrical device circuit board. In the illustrated embodiment shown in FIG. 1 through FIG. 4, the flashlight 20 comprises four recessed electrical contacts 26 which are accessible through the first side 30 of said housing 22. The recessed electrical contacts 26 are protected thereby from accidental contact with foreign objects. The housing 22 preferably also comprising a second side 32 opposite the first side 30.

In the embodiment illustrated in FIG. 1 through FIG. 4, the housing 22 at said first side 30, preferably adjacent said contact(s) 26, comprises a second magnetic portion 28. It is preferred that the second magnetic portion 28 comprises one or more magnets located inside said housing 22. While the illustrated embodiment includes a second magnetic portion, other embodiments may instead include a ferromagnetic portion able to be attracted to a magnetic portion, for instance a first magnetic portion located in the base 50. It is preferred that the first magnetic portion 64 be oriented in the base 50 and the second magnetic portion 28 be oriented in the flashlight 20 so that their polarities with respect to one another are aligned, thereby enabling the magnetic portions 28, 64 to be better attracted to one another. Preferably, the magnet poles are oriented such that the attractive force between the two magnets pulls the flashlight toward the charger. The attraction between the two devices brings the electrical contacts of the charger into contact with the electrical contacts of the flashlight.

It is preferred that the contact(s) 26 be located in a recess 42. The recess 42 configured and sized for mating receipt with the projection 63 of the base 50, as discussed above.

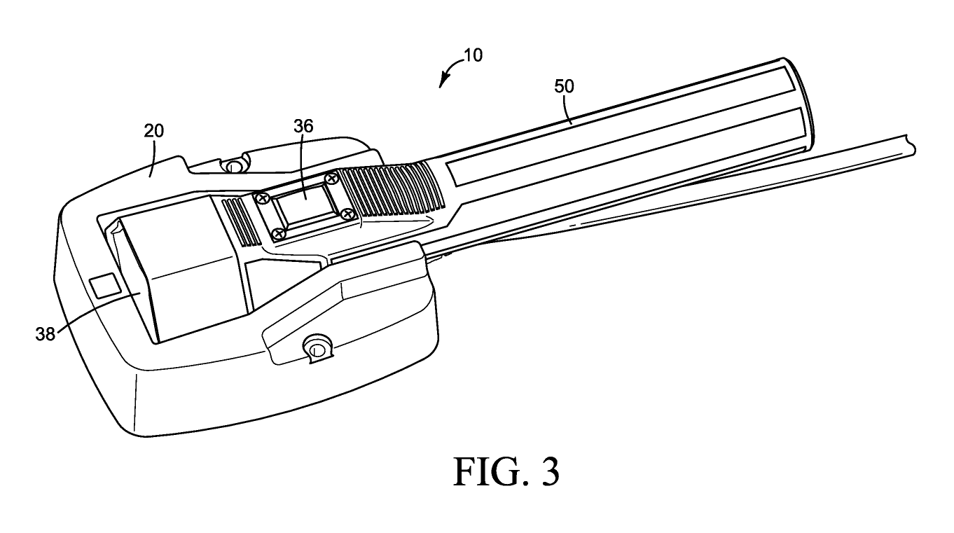

The flashlight 20 preferably having a head portion 34 and a handle portion 40. The handle portion 40 configured for grasping by a user of the flashlight 20. The head portion 34 preferably including the power/function button(s) 36 (as shown in FIG. 3). While the preferred location of the power/function button(s) 36 is the head portion 34, such buttons/switches may be located elsewhere (either alternatively or exclusively). For instance, a tail button may be located in the tail 44. It is further preferred that the second magnetic portion 28, electrical contact(s) 26, and lens/bulb portion 38 be located in the head portion 34 of the flashlight 20.

The second magnetic portion 28 configured for magnetic attraction to said first magnetic portion 64. As such, when the rechargeable flashlight 20 is connected to the base 50, magnetic attraction between the first magnetic portion 64 and the second magnetic portion 28 holds the head portion 34 of said rechargeable flashlight 20 nested within the receiver portion 54 with the body electrical contact(s) 62 and said rechargeable flashlight electrical contacts 26 held in electrical contact with one another in position for the charger 58 to charge said energy pack 24. In such a configuration, while charging takes place, the handle portion 40 of the flashlight 20 extends from the base 50.

It is preferred that the first magnetic portion 64 be located in said receiver portion 54 adjacent said at least one electrical contact 62, and the second magnetic portion 28 be located in the head portion 34 adjacent said at least one electrical contact 26, thereby enabling a tight electrical connection between the electrical contact(s) 26, 62. The electrical connection allowing the charger 58 to charge the energy pack 24.

In the preferred embodiment, the energy pack comprises three (3) pseudocapacitors (2.3 v, 300 F). The preferred embodiment further comprising suitable circuitry for allowing the pseudocapacitors to power one or more light emitting diodes (LEDs), for instance high efficiency white LEDs. Other embodiments of rechargeable flashlights may utilize incandescent bulbs instead of light emitting diodes.

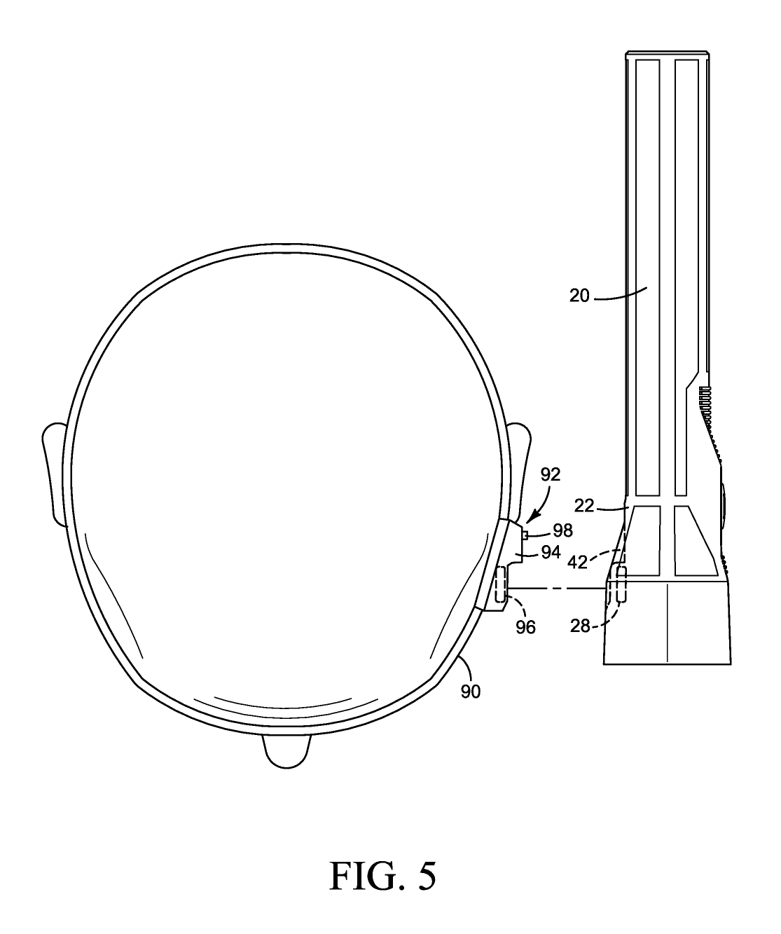

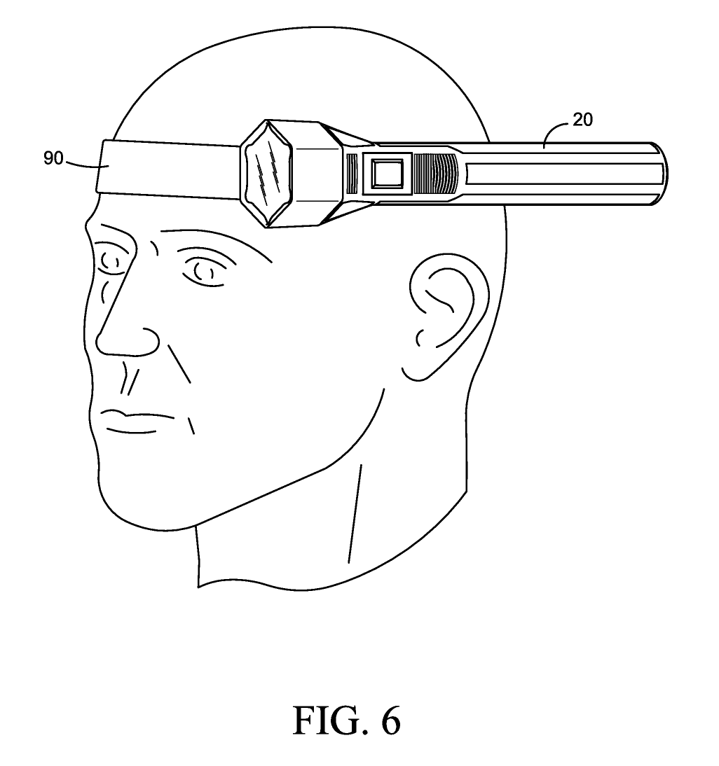

Referring now to FIG. 5 and FIG. 6, shown is a second illustrated embodiment of the inventive concept(s). In these Figures, the flashlight 20 (or other electrical device) is able to attach to an accessory 90, thereby allowing for hands-free use of the electronic device. The accessory 90 having a connector 92 having a projection 94 shaped for mating with the recess 42 in the housing 22 of the flashlight 20. Preferably, a third magnetic portion 96 is provided which magnetically couples with the second magnetic portion 28 of the flashlight 20 thereby enabling a user to wear the accessory 90 with the flashlight 20 (or other electrical device) connected there-to. Alternatively, the third magnetic portion 96 could comprise a strip of metal or other ferromagnetic material able to magnetically bind to the second magnetic portion 28. FIG. 5 illustrating the flashlight 20 not connected to the accessory 90, whereas FIG. 6 illustrates the flashlight 20 connected to the accessory 90.

Preferably, the accessory 90 comprises at least one third electrical contact 98. When the electrical device (e.g., flashlight 20) is connected to said accessory 90, the at least one third electrical contact 98 and the at least one second electrical contact 26 of the electrical device are held in electrical contact with one another.

The accessory 90, in other embodiments could include (but not be limited to) articles of clothing (e.g., garments, belts, hats, arm bands, headbands, hatbands, headgear, attachments garments) and physical mounts (e.g., a mounting bracket fixed to a surface, a mounting bracket fixed to a surface).

Embodiments of the inventive concept(s) are also useful for devices that must be placed in close proximity for proper functioning, such as devices utilizing the Bluetooth® protocol (a “Bluetooth® device”). Bluetooth® devices have a limited range of wireless connectivity. At times it is convenient to store or place two Bluetooth® devices near each other for data transfer or other communication, e.g., a cell phone and an automobile. One embodiment of the inventive concept(s) is a connector (physical mount) built into the console or other component of an automobile's interior that is able to connect to a magnetic portion in a cell phone thereby bringing the cell phone's Bluetooth® transceiver into ideal communication with the automobile's Bluetooth® transceiver and positioning the cell phone in a desired orientation for the user to interact with the cell phone (e.g., reading of global positioning satellite (GPS) data).

### Example Embodiments

### Embodiment 1

In a first example embodiment, the inventive concept(s) comprises a charger base and a rechargeable flashlight. The base comprising a body having a receiver portion defined therein. The receiver portion configured for nesting receipt of a head portion of the rechargeable flashlight therein. The base comprising a charger powered by a power source. The charger for charging the rechargeable flashlight's energy pack. The charger comprising at least one electrical contact extending from the receiver portion. The base comprising a first magnet in the receiver portion adjacent the electrical contact(s). The rechargeable flashlight having a housing. An energy pack, preferably including a plurality of ultracapacitors, for storing energy is located in the housing. The rechargeable flashlight comprising at least one electrical contact accessible through the housing for connection with the electrical contact of the charger. The rechargeable flashlight comprising a second magnet inside the housing, this second magnet configured for magnetic attraction to the first magnet so that magnetic attraction holds the head portion of the rechargeable flashlight nested within the receiver portion of the base with the charger's electrical contacts and the rechargeable flashlight electrical contacts held in electrical contact with one another.

### Embodiment 2

In a second example embodiment, the inventive concept(s) comprise a small handheld light unit with rechargeable batteries or capacitors with LEDs that are magnetically coupled to a charging base and charged up. Once charged, the unit is placed on a head strap and used as a head lamp.

### Embodiment 3

In a third example embodiment, the inventive concept(s) comprise a small handheld light unit with rechargeable batteries or capacitors with LEDs that are magnetically coupled to a charging base and charged up. When in the charging base, the light unit can be used to provide continuous light output. In such a configuration, the system may be used as a stationary light (e.g., a drop light for mechanics), but can also be easily removed from the charger to illuminate remote locations. Further, the system can be positioned upon a ferrous surface (e.g., the frame of an automobile) to light up a desired area.

### Embodiment 4

In a fourth example embodiment, the inventive concept(s) comprise a small handheld light unit with rechargeable batteries or capacitors with LEDs that are magnetically coupled to a charging base and charged up. Once charged, the unit is placed in a lantern style housing with a diffuser for emitting light in 360 degrees.

### Embodiment 5

In a fifth example embodiment, the inventive concept(s) comprise a small handheld light unit with rechargeable batteries or capacitors with LEDs that are magnetically coupled to a charging base and charged up. Once charged, the unit is attached to a bracket for a bicycle for use as a bicycle headlight.

### Embodiment 6

In a sixth example embodiment, the inventive concept(s) comprise a modular charging unit or programming unit. In this embodiment, the lamp unit could be magnetically and electronically connected to a solar panel or hand-crank for recharging.

### Embodiment 7

In a seventh example embodiment, the inventive concept(s) comprise a modular charging unit or programming unit (the base) used with a light unit. The base designed to change the functionality of the light unit once connected, thereby providing the user of the system with an interface to change the programming of the system, e.g., output, run time, flashing functions. Preferably, even when the light unit and base are not physically connected together, the base can still electrically communicate with the light unit, for instance using a protocol like Bluetooth®.

### Embodiment 8

In this embodiment of the inventive concept(s), the electrical device is configured to be magnetically attached to a surface, e.g., the hood of a car, an appliance, a ferrous plate, a metal strap.

### Embodiment 9

In this embodiment of the inventive concept(s), the system can be used to mount heavy service flashlights for storage and use on fire and emergency response vehicles.

### Embodiment 10

In this embodiment of the inventive concept(s), the system could be used for placing lights in medical or surgical environments.

### Embodiment 11

In this embodiment of the inventive concept(s), only the flashlight has a magnetic portion.

### Embodiment 12

In this embodiment of the inventive concept(s), the flashlight and the base each have a magnetic portion.

### Embodiment 13

In this embodiment of the inventive concept(s), the base has a magnetic portion, but the flashlight does not.

### Embodiment 14

In this embodiment of the inventive concept(s), the system could be used to affix flashlights to firearms.

While certain exemplary embodiments are shown in the Figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. A system comprising: a charging base and an electrical device having a head portion; said charging base comprising a body, said charging base comprising a receiver portion in said body for nesting receipt of the head portion of said electrical device therein, said receiver portion connected to a charger powered by a power source, said charger for charging said electrical device, said charger comprising at least one first electrical contact, the receiver portion comprising a first magnetic portion adjacent said at least one first electrical contact; and the electrical device comprising a housing, the electrical device comprising at least one energy pack for storing energy, the electrical device comprising at least one second electrical contact accessible through said housing, the electrical device comprising a second magnetic portion inside said housing, said second magnetic portion configured for magnetic attraction to said first magnetic portion so that said magnetic attraction holds the head portion of said electrical device nested within said receiver portion with said at least one first electrical contact and said at least one second electrical contact in electrical contact with one another.

2. The system of claim 1, wherein said first magnetic portion comprises at least one magnet.

3. The system of claim 1, wherein said second magnetic portion comprises at least one magnet.

4. The system of claim 1, wherein said first magnetic portion comprises a ferromagnetic material.

5. The system of claim 1, wherein said second magnetic portion comprises a ferromagnetic material.

6. The system of claim 1, wherein said electrical device comprises a handle portion, wherein when said head portion is nested within said receiver portion, said handle portion extends away from said charging base.

7. The system of claim 1, wherein said electrical device is a rechargeable flashlight.

8. The system of claim 7, wherein said rechargeable flashlight comprises at least one light emitting diode.

9. The system of claim 1, wherein said at least one energy pack comprises at least one advanced capacitor.

10. The system of claim 1, wherein said at least one energy pack comprises at least one rechargeable battery.

11. The system of claim 1, further comprising an accessory, said accessory comprising a connector comprising a third magnetic portion, said connector able to connect with said second magnetic portion when said first magnetic portion is not magnetically attracted to said second magnetic portion, thereby allowing said electrical device to be connected to said accessory.

12. The system of claim 11, wherein said third magnetic portion comprises at least one magnet.

13. The system of claim 11, wherein said third magnetic portion comprises a ferromagnetic material.

14. The system of claim 11, wherein said accessory is an article of clothing.

15. The system of claim 14, wherein said article of clothing is a headband.

16. The system of claim 11, wherein said accessory comprises a physical mount, said physical mount comprising a connector able to connect with said second magnetic portion, said physical mount able to be affixed to a surface, thereby allowing said electrical device to be removably attached to said surface.

17. The system of claim 11, wherein said accessory comprises at least one third electrical contact, wherein when electrical device is connected to said accessory, said at least one third electrical contact and said at least one second electrical contact are held in electrical contact with one another.

18. The system of claim 1, wherein said at least one first electrical contact comprises at least one spring probe.

19. The system of claim 1, wherein said first electrical contacts are located on a projection in said receiver portion and said electrical device housing defines a recess therein for mating receipt of said projection, said second electrical contacts located in said recess.

20. The system of claim 1, wherein said electrical device further comprises a circuit board, and said at least one second electrical contact is at least one contact on said electrical device circuit board; and said base further comprising a circuit board, and said at least one first electrical contact is at least one spring probe extending from said base circuit board.

21. A system comprising: a charging base and a rechargeable flashlight having a head portion and a handle portion; the charging base comprising a body, said charging base defining a receiver portion in said body for nesting receipt of the head portion of said rechargeable flashlight therein, said receiver portion comprising a charger powered by a power source, said charger for charging said rechargeable flashlight, said charger comprising at least one first electrical contact extending from said receiver portion, said at least one first electrical contact comprising at least one spring probe, the receiver portion comprising a first magnet adjacent said at least one electrical contact; and the rechargeable flashlight comprising a housing, the rechargeable flashlight comprising at least one energy pack for storing energy, said energy pack comprising a plurality of advanced capacitors, said rechargeable flashlight comprising at least one light emitting diode, said rechargeable flashlight comprising at least one second electrical contact accessible through said housing, the rechargeable flashlight comprising a second magnet inside said housing, said second magnet configured for magnetic attraction to said first magnet so that said magnetic attraction holds the head portion of said rechargeable flashlight nested within said receiver portion of said receiver portion with said at least one first electrical contact and said at least one second electrical contact in electrical contact with one another.
